(19) United States
(12) Patent Application Publication
(10) Pub. No.: US 2025/0196043 A1
(43) Pub. Date: Jun. 19, 2025

(54) AIR FILTER SYSTEM FOR DETECTING DIFFERENTIAL ELECTRICAL PROPERTIES TO INDICATE A NEED FOR SERVICING

(71) Applicant: K&N ENGINEERING, INC., Riverside, CA (US)

(72) Inventors: Steve Williams, Cherry Valley, CA (US); Joost Adriaans, Riverside, CA (US)

(73) Assignee: K&N ENGINEERING, INC., Riverside, CA (US)

(21) Appl. No.: 18/981,355

(22) Filed: Dec. 13, 2024

Related U.S. Application Data
(60) Provisional application No. 63/610,029, filed on Dec. 14, 2023.

(51) Int. Cl. B01D 46/00; F24F 8/108

(52) U.S. Cl. CPC B01D 46/0086; B01D 46/0005; F24F 8/108; B01D 2279/50

(57) ABSTRACT

A system and methods are provided for an air filter that detects changes in electrical properties of electrodes in the filter and determines a corresponding pressure differential across the filter to indicate when the filter needs to be serviced. The air filter comprises a filter medium supported within a frame and a differential electrical properties detector incorporated into the filter medium. The frame supports the filter medium within a HVAC system, and the filter medium removes contaminants from an airstream flowing through the HVAC system. The differential electrical properties detector signals when air pressure across the air filter reaches a threshold value due to contaminant buildup within the filter medium. The differential electrical properties detector wirelessly signals an application stored on a user's mobile device to display a notification to the user when the air filter needs to be cleaned or replaced to minimize energy consumption by the HVAC system.

### PRIORITY

This application claims the benefit of and priority to U.S. Provisional Application, entitled “Air Filter System For Detecting Differential Electrical Properties To Indicate A Need For Servicing,” filed on Dec. 14, 2023, and having application Ser. No. 63/610,029, the entirety of said application being incorporated herein by reference.

### FIELD

Embodiments of the present disclosure generally relates to filter devices. More specifically, embodiments of the disclosure relate to a system and methods for an air filter that can detect changes in electrical properties of electrodes in the filter and determine corresponding a differential pressure across the filter, due to contaminant buildup, and thus provide insight as to when to periodically service the filter.

### BACKGROUND

An air filter designed to remove particulate matter from an airstream generally is a device comprising fibrous materials. These fibrous materials can remove solid particulates such as dust, pollen, mold, and bacteria from an airstream. Air filters are used in applications where air quality is important, notably in heating, ventilation, and air conditioning (HVAC) systems of buildings. HVAC systems generally operate to provide optimal interior air quality to occupants within interior spaces of buildings. HVAC systems achieve optimal interior air quality by conditioning air, removing particle contaminants by way of ventilation and filtration of air, and providing a proper interior pressurization.

While there are many different HVAC system designs and operational approaches, and each building design is unique, HVAC systems generally share a few basic design elements. For example, outside air (“supply air”) generally is drawn into a HVAC system through an air intake. Once in the HVAC system, the supply air is filtered to remove particle contaminants, then heated or cooled, and then circulated throughout the interior space of the building by way of an air distribution system. Many air distribution systems comprise a return air system configured to draw air from the interior building space and return the air (“return air”) to the HVAC system. The return air may then be mixed with supply air and then filtered, conditioned, and circulated throughout the interior space of the building. In some instances, a portion of the air circulating within the building may be exhausted to the exterior so as to maintain a desired barometric pressure within the building.

As will be appreciated, the effectiveness of the HVAC system to provide an optimal interior air quality depends largely on an ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. Filters may be made from paper, foam, cotton, spun fiberglass, or other known filter materials. The filter material may also be pleated so as to increase the surface area and, accordingly, increase the efficiency of the filter. As will be appreciated, an increase in the number of pleats for a given area will proportionally increase the surface area and therefore the efficiency of the filter.

A drawback to conventional HVAC system air filters is that highly effective air filters capable of removing very small contaminants, such as airborne molecular contaminants and volatile organic compounds (VOCs), tend to restrict airflow through the air filter, thereby making the HVAC system work harder and consume more energy. As such an air filter becomes increasingly clogged with contaminants, the pressure downstream of the filter drops while the atmospheric air pressure upstream of the filter remains the same. When the pressure differential becomes too great, due to clogging, the filter may tear or burst, allowing contaminants to be pulled beyond the air filter. Thus, the performance of a conventional HVAC system air filter (i.e., air flow through the filter and its ability to remove contaminants from the airstream) decreases over the course of the filter's service life.

Another drawback to conventional HVAC system air filters is that dirty or clogged air filters typically must be removed from the HVAC system and discarded, and a new HVAC system air filter must be installed. As such, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is a staggering number.

What is needed, therefore, is a HVAC system air filter that can detect changes in electrical properties of electrodes in the filter and determine a corresponding pressure differential across the filter, due to contaminant buildup, and thus provide insight as to when to periodically clean and reuse the filter so as to minimize obstructing air flow through the HVAC system.

### SUMMARY

A system and methods are provided for an air filter that detects changes in electrical properties of electrodes in the filter and determines a corresponding pressure differential across the filter, due to contaminant buildup, to indicate when the filter needs to be serviced. The air filter comprises a filter medium supported within a frame and a differential electrical properties detector incorporated into the frame. The frame supports the filter medium within a HVAC system, and the filter medium removes contaminants from an airstream flowing through the HVAC system. The differential electrical properties detector signals when air pressure across the air filter reaches a threshold value due to contaminant buildup within the filter medium. The differential electrical properties detector includes circuitry that wirelessly signals an application stored on a user's mobile device to display a notification to the user when the air filter needs to be cleaned or replaced to minimize energy consumption by the HVAC system.

In an exemplary embodiment, an air filter for a HVAC system comprises: a filter medium comprising one or more media layers for removing contaminants from an airstream; a frame for supporting the filter medium within the HVAC system; and a differential electrical properties detector for determining a pressure difference across the filter medium.

In another exemplary embodiment, the differential electrical properties detector comprises: a plurality of electrodes disposed in the filter medium; and a first connector and a second connector that are incorporated into the frame. In another exemplary embodiment, the plurality of electrodes comprises electric wires that are extended across the filter medium, parallel to pleats comprising the filter medium, and placed into electrical communication with the first connector and the second connector. In another exemplary embodiment, either one or more of the first connector and the second connector are configured to interface with suitable connectors implemented in the HVAC system such that the electrodes are placed into electrical communication with circuitry disposed in the HVAC system. In another exemplary embodiment, the circuitry is configured to detect changes in the electrical properties of the plurality of electrodes and then use the changes to determine a corresponding pressure differential across the filter. In another exemplary embodiment, the circuitry is configured to use the corresponding pressure differential to determine when the air filter must be cleaned or replaced to minimize obstruction to air flow through the HVAC system. In another exemplary embodiment, the circuitry is configured to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof.

In another exemplary embodiment, the plurality of electrodes comprises a first electrode and a second electrode are disposed in, and extended along, each pleat comprising the filter medium. In another exemplary embodiment, the first electrode and the second electrode are disposed in the pleat such that the first electrode and the second electrode become buried as the pleat fills with a buildup of contaminants. In another exemplary embodiment, the differential electrical properties detector is configured to detect any one or more of a resistance, a capacitance, and an impedance exhibited by the first electrode and the second electrode. In another exemplary embodiment, the differential electrical properties detector is configured to detect changes to any one or more of the resistance, the capacitance, and the impedance due to the buildup of contaminants. In another exemplary embodiment, the differential electrical properties detector is configured to use the changes to any one or more of the resistance, the capacitance, and the impedance to determine a corresponding differential pressure across the air filter.

In another exemplary embodiment, the first electrode and the second electrode comprise gold plated wires that are embedded into the pleats of the filter medium. In another exemplary embodiment, the first electrode and the second electrode comprise graphene-based screen-printed conductive ink that is applied to the pleats of the filter medium. In another exemplary embodiment, the first electrode and the second electrode comprise copper wires that are embedded into the pleats of the filter medium.

In another exemplary embodiment, the differential electrical properties detector comprises a measurement device, a first excitation lead and a second excitation lead, and a first detection lead and a second detection lead. In another exemplary embodiment, the first excitation lead and the first detection lead are configured to be connected to the first connector, while the second excitation lead and the second detection lead are configured to be connected to the second connector. In another exemplary embodiment, the measurement device is configured to pass a test current through the electrodes by way of the first excitation lead and the second excitation lead. In another exemplary embodiment, the measurement device is configured to measure at least the voltage across the electrodes by way of the first detection lead and the second detection lead. In another exemplary embodiment, the measurement device is configured to measure any one or more of the voltage, resistance, capacitance, or impedance of the electrodes.

In an exemplary embodiment, a method for an air filter for a HVAC system comprises: fabricating a filter medium comprising one or more media layers for removing contaminants from an airstream; disposing the filter medium within a frame for supporting the filter medium within the HVAC system; configuring a differential electrical properties detector for determining a pressure difference across the filter medium; and coupling the differential electrical properties detector with the filter medium.

In another exemplary embodiment, configuring the differential electrical properties detector comprises: disposing a plurality of electrodes in the filter medium; and incorporating a first connector and a second connector into the frame. In another exemplary embodiment, disposing the plurality of electrodes comprises extending electric wires across the filter medium, parallel to pleats comprising the filter medium, and placing the electric wires into electrical communication with the first connector and the second connector. In another exemplary embodiment, incorporating either one or more of the first connector and the second connector comprises configuring either one or more of the first connector and the second connector to interface with connectors implemented in the HVAC system such that the electrodes are placed into electrical communication with circuitry disposed in the HVAC system. In another exemplary embodiment, configuring the differential electrical properties detector comprises configuring the circuitry to detect changes in the electrical properties of the plurality of electrodes and then use the changes to determine a corresponding pressure differential across the filter. In another exemplary embodiment, configuring the circuitry includes configuring the circuitry to use the corresponding pressure differential to determine when the air filter must be cleaned or replaced to minimize obstruction to air flow through the HVAC system. In another exemplary embodiment, configuring the circuitry includes configuring the circuitry to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof.

In another exemplary embodiment, disposing the plurality of electrodes comprises extending a first electrode and a second electrode along each pleat comprising the filter medium. In another exemplary embodiment, extending the first electrode and the second electrode includes disposing the first electrode and the second electrode in the pleat such that the first electrode and the second electrode become buried as the pleat fills with a buildup of contaminants. In another exemplary embodiment, configuring the differential electrical properties detector includes configuring the differential electrical properties detector to detect any one or more of a resistance, a capacitance, and an impedance exhibited by the first electrode and the second electrode. In another exemplary embodiment, configuring the differential electrical properties detector includes configuring the differential electrical properties detector to detect changes to any one or more of the resistance, the capacitance, and the impedance due to the buildup of contaminants. In another exemplary embodiment, configuring the differential electrical properties detector includes configuring the differential electrical properties detector to use the changes to any one or more of the resistance, the capacitance, and the impedance to determine a corresponding differential pressure across the air filter.

In another exemplary embodiment, extending the first electrode and the second electrode comprises embedding gold plated wires into the pleats of the filter medium. In another exemplary embodiment, extending the first electrode and the second electrode comprises applying graphene-based screen-printed conductive ink to the pleats of the filter medium. In another exemplary embodiment, extending the first electrode and the second electrode comprise embedding copper wires into the pleats of the filter medium.

In another exemplary embodiment, configuring the differential electrical properties detector comprises coupling a measurement device with a first excitation lead, a second excitation lead, a first detection lead, and a second detection lead. In another exemplary embodiment, configuring the differential electrical properties detector comprises configuring the first excitation lead and the first detection lead to be connected to the first connector, while the second excitation lead and the second detection lead are configured to be connected to the second connector. In another exemplary embodiment, configuring the differential electrical properties detector comprises configuring the measurement device to pass a test current through the electrodes by way of the first excitation lead and the second excitation lead. In another exemplary embodiment, configuring the differential electrical properties detector comprises configuring the measurement device to measure at least the voltage across the electrodes by way of the first detection lead and the second detection lead. In another exemplary embodiment, configuring the differential electrical properties detector comprises configuring the measurement device to measure any one or more of the voltage, resistance, capacitance, or impedance of the electrodes.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary use environment wherein a HVAC system air filter is incorporated into a HVAC system of a building, according to the present disclosure;

FIG. 2 illustrates a schematic view of an exemplary embodiment of a HVAC system comprising a HVAC air filter in accordance with the present disclosure;

FIG. 3 illustrates an exemplary embodiment of an air filter having a differential electrical properties detector coupled with a supportive frame of the air filter, according to the present disclosure;

FIG. 4 illustrates a cross-sectional view of the air filter and differential electrical properties detector of FIG. 3, taken along line 4-4, in accordance with the present disclosure;

FIG. 5 illustrates a circuit diagram of an exemplary embodiment of a differential electrical properties detector configured to detect a change in resistance or capacitance of electrodes in a filter medium due to a buildup of contaminants, in accordance with the present disclosure;

FIG. 6 is a block diagram illustrating an exemplary embodiment of power circuit for supplying electrical power to a differential electrical properties detector, according to some embodiments; and

FIG. 7 provides an exemplary block illustration of a data processing system that may be used in conjunction with an air filter and differential electrical properties detector in accordance with various embodiments of the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the air filter system and methods disclosed herein may be practiced without these specific details. In other instances, specific numeric references such as “first media layer,” may be made. However, the specific numeric reference should not be interpreted as a literal sequential order but rather interpreted that the “first media layer” is different than a “second media layer.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, a HVAC system air filter comprises fibrous materials configured to remove solid particulates, such as dust, pollen, mold, and bacteria from an airstream passing through the HVAC system. Filters may be made from paper, foam, cotton, spun fiberglass, or other known filter materials. A drawback to conventional HVAC system air filters is that highly effective air filters capable of removing very small contaminants tend to restrict the airstream through the air filter, thereby making the HVAC system work harder and consume more energy. As such an air filter becomes increasingly clogged with contaminants, the pressure downstream of the filter drops while the atmospheric air pressure upstream of the filter remains the same. When the pressure differential becomes too great, due to clogging, the filter may tear or burst, allowing contaminants to be pulled beyond the air filter. Thus, the performance of a conventional HVAC system air filter (i.e., air flow through the filter and its ability to remove contaminants from the airstream) decreases over the course of the filter's service life.

Embodiments presented herein disclose a HVAC system air filter that can detect changes to electrical properties of electrodes coupled with the filter, due to contaminant buildup, and thus determine a corresponding pressure differential across the filter so as to provide insight as to when to periodically clean and reuse the filter to minimize obstructed air flow through the HVAC system.

Although embodiments presented herein may be described and illustrated in terms of a rectangular air filter, it should be understood that the air filter is not to be limited to the exact embodiments or shapes illustrated, but rather the air filter may include a wide variety of generally rectangular shapes, generally square, circular, oval, round, curved, conical, or other closed perimeter shape that will become apparent. Moreover, embodiments as described herein are not limited to use with an HVAC system and may find applicability in any of various other filtration systems configured to treat a large volume of air.

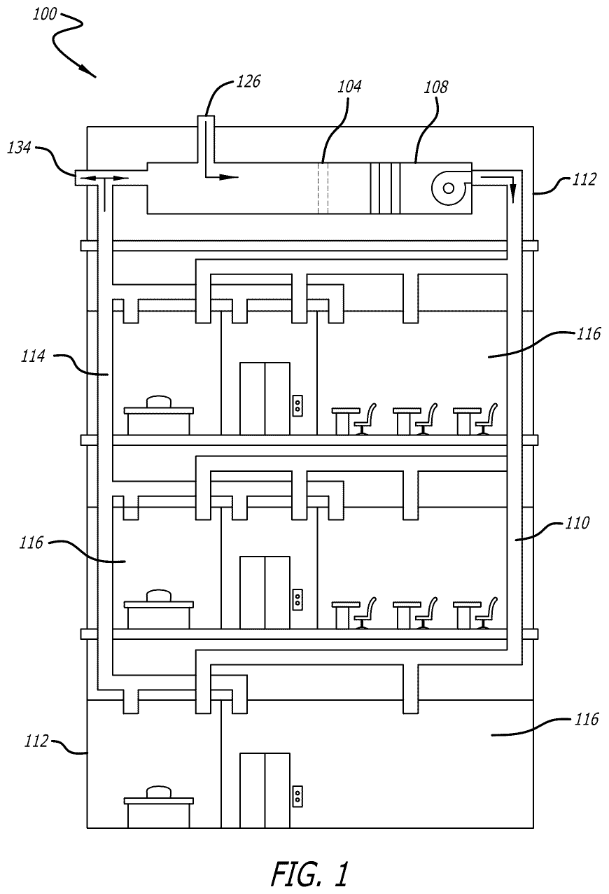

FIG. 1 illustrates an exemplary-use environment 100 wherein an air filter 104 is incorporated into a HVAC system 108 of a building 112 so as to clean an airstream drawn through the air filter 104. Although the building 112 illustrated in FIG. 1 comprises a multi-story office building, it should be understood that the building 112 may comprise any of various inhabitable structures, such as residential homes, apartments, condominiums, and the like. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which may include one or more building spaces 116, as illustrated in FIG. 1, or may comprise a single-story building, including but not limited to a detached residential home.

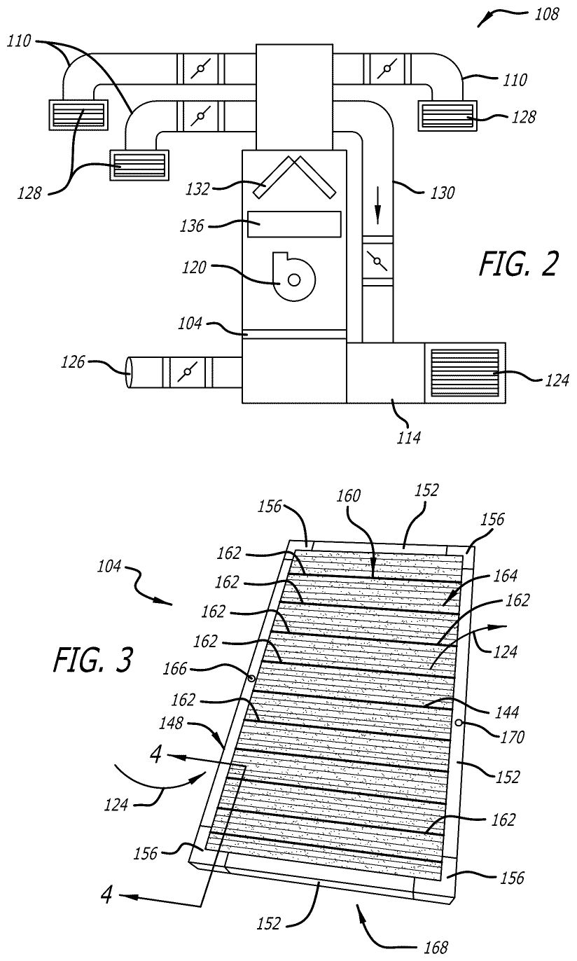

FIG. 2 illustrates a schematic view of an exemplary embodiment of a HVAC system 108 that may be used to clean air within building spaces 116. In some embodiments, however, the HVAC system 108 may be configured to clean air within interior spaces of any of a wide variety of buildings without limitation. The HVAC system 108 generally comprises a fan 120 configured to draw a return airstream 124 from the building spaces 116 through the air filter 104 whereby airborne molecular contaminants or other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 so as to maintain a desired barometric pressure within the HVAC system 108 and within the building spaces 116. In some embodiments, an exhaust airstream 134 may be further incorporated into the HVAC system 108 so as to maintain the desired barometric pressure and to allow entry of the outside airstream 126.

FIG. 3 illustrates an exemplary embodiment of an air filter 104 according to the present disclosure. The air filter 104 generally comprises a filter medium 144 within a supportive frame 148. The supportive frame 148 is configured to orient the air filter 104 within the HVAC system 108 such that the return air stream 124 is directed through the filter medium 144. As such, the supportive frame 148 comprises a shape and size suitable for supporting the air filter 104 within the HVAC system 108. It will be appreciated that the shape and size of the supportive frame 148 will vary depending upon a make and model of the HVAC system 108 for which the air filter 104 is intended to be used.

In some embodiments, the supportive frame 148 may comprise various fastening, or supportive, structures and materials suitably configured for securing the air filter 104 within a particular HVAC system 108. To this end, in the embodiment illustrated in FIG. 3, the supportive frame 148 comprises a plurality of elongate sections 152 and corner sections 156 disposed along the perimeter edges of the filter medium 144 and configured to support the filter medium 144 within the HVAC system 108. In other embodiments, however, the supportive frame 148 may comprise any of various rigid supports and recesses configured to orient the air filter 104 within various makes and models of HVAC system 108. As will be recognized, the supportive frame 148 may be configured with a variety of different shapes than the shape of the supportive frame illustrated in FIG. 3. It should be understood, therefore, that the various structures, shapes, and materials incorporated into the supportive frame 148, and thus the air filter 104 as a whole, may vary depending upon the particular HVAC system 108 for which the air filter 104 is intended to be used without detracting from the spirit and scope of the present disclosure.

It is contemplated that a practitioner may periodically clean the filter medium 144 rather than replacing the air filter 104, as is typically done with conventional air filter systems. It is envisioned that the air filter 104 may be removed from the HVAC system 108, any trapped debris may then be removed from the HVAC system 108. In some embodiments, the elongate sections 152 and the corner sections 156 may be disassembled to release the filter medium 144 from the supportive frame 148 and then a water hose may be used to flush contaminants from the filter medium 144, thereby leaving the filter clean and ready for reuse. In some embodiments, wherein the filter medium 144 comprises a filter oil composition, a solvent may be used to remove the filter oil from the filter medium 144. Once the filter medium 144 is sufficiently dry, a suitably formulated filter oil composition may be applied and allowed to wick into the filter medium 144. The elongate sections 152 and corner sections 156 may then be assembled onto the filter medium, as described above, and the air filter 104 may be reinstalled into the HVAC system 108. Various other cleaning methods will be apparent to those skilled in the art without deviating from the spirit and scope of the present disclosure.

As further illustrated in FIG. 3, an exemplary embodiment of a differential electrical properties detector 160 is incorporated into the air filter 104. The differential electrical properties detector 160 is configured to detect changes in electrical properties of electrodes in the filter medium 144 and determine a corresponding differential pressure across the air filter 104, due to contaminant buildup, and thus provide insight as to when to periodically service the filter 104.

It should be understood that as the air filter 104 removes particle contaminants from the airstream 124, the contaminants become entrapped in the filter medium 144. As the volume of contaminants grows, so does resistance to the airstream 124 flowing through the air filter 104. Consequently, the air pressure downstream of the air filter 104 decreases with respect to the atmospheric pressure upstream of the air filter 104, giving rise to a low-pressure side 164 of the air filter 104 and an atmospheric-pressure side 168 of the air filter 104, as shown in FIG. 3. The difference in pressure between the low-pressure side 164 and the atmospheric-pressure side 168 of the air filter 104 causes the HVAC system 108 to consume more energy to continue moving the airstream 124 through the air filter 104. It is contemplated that changes in electrical properties of electrodes in the filter medium 144 can be used to indicate when the pressure across the filter medium 144 reaches a predetermined threshold value, at which point the air filter 104 may be serviced or replaced to minimize the energy consumption of the HVAC system 108.

In the illustrated embodiment of FIG. 3, the differential electrical properties detector 160 includes a plurality of electrodes 162 disposed in the filter medium 144, as well as a first connector 166 and a second connector 170 that are incorporated into the frame 148. The electrodes 162 may comprise electric wires that are extended across the filter medium 144, parallel to pleats comprising the filter medium 144, and placed into electrical communication with the first and second connectors 166, 170. The first and second connectors 166, 170 may be configured to interface with suitable connectors implemented in the HVAC system 108 such that the electrodes 162 may be placed into electrical communication with circuitry disposed in the HVAC system 108. It is contemplated that the circuitry can be configured to detect changes in the electrical properties of the electrodes 162 and then use the changes to determine a corresponding pressure differential across the filter 104. The pressure differential can then be used, in turn, to provide insight as to when to clean or replace the filter 104 to minimize obstruction to air flow through the HVAC system.

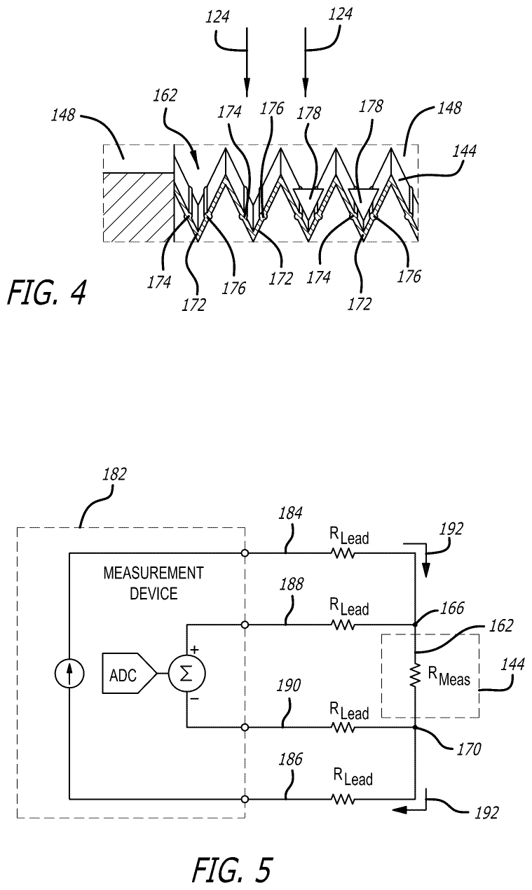

FIG. 4 illustrates a cross-sectional view of a portion of the filter medium 144 and the differential electrical properties detector 160 comprising the air filter 104 of FIG. 3. As described with respect to FIG. 3, the differential electrical properties detector 160 includes a plurality of electrodes 162 that are extended across the filter medium 144, parallel to pleats 172 comprising the filter medium 144, and placed into electrical communication with the first and second connectors 166, 170. More specifically, a first electrode 174 and a second electrode 176 are disposed in each pleat 172 and extended across the filter medium 144. For exemplary purposes, FIG. 4 shows two pleats 172 that are filled with a buildup of contaminants 178, such that the first and second electrodes 174, 176 are buried, and two pleats 172 that are empty of any contaminant buildup.

As will be appreciated, the contaminants 178 have different electrical properties than normal air. For example, the contaminants 178 generally will have a greater dielectric constant than the dielectric constant of normal air. Thus, while the electrodes 174, 176 disposed in a clean air filter 104 exhibit an initial resistance, capacitance, and impedance, the measured resistance, capacitance, and impedance will change over time as the electrodes 174, 176 become increasingly buried by contaminants 178 that are entrapped in the filter medium 144. It is contemplated, therefore, that changes to any one or more of the resistance, capacitance, or impedance exhibited by the plurality of first and second electrodes 174, 176 disposed in the pleats 172 can be used to determine a corresponding pressure differential across the filter 104. The pressure differential can then be used, in turn, to provide insight as to when to clean or replace the filter 104 so as to minimize obstruction to air flow through the HVAC system 108.

Moreover, it should be borne in mind that the plurality of first and second electrodes 174, 176 may be implemented in a wide variety of configurations without deviating beyond the present disclosure. In some embodiments, for example, the first and second electrodes 174, 176 comprise gold plated wires that are embedded into the pleats 172 of the filter medium 144. Such embodiments may be used to measure changes to the resistance and/or the capacitance of the first and second electrodes 174, 176 due to a buildup of contaminants 178. In some embodiments, screen printed conductive ink may be used to form the first and second electrodes 174, 176. For example, the first and second electrodes 174, 176 may comprise graphene-based screen-printed conductive ink that is applied to a thickness of about 30 micrometers. As with embodiments incorporating gold plated wires, embodiments comprising graphene-based conductive ink may be used to measure changes to the resistance and/or the capacitance of the first and second electrodes 174, 176 due to the buildup of contaminants 178. However, in some embodiments, the first and second electrodes 174, 176 may comprise copper wires. As will be appreciated, embodiments employing copper wires for the first and second electrodes 174, 176 may be used to measure changes to the capacitance of the first and second electrodes 174, 176 due to the buildup of contaminants 178.

FIG. 5 illustrates a circuit diagram of an exemplary embodiment of a differential electrical properties detector 180 configured to detect a change in resistance or capacitance of electrodes 162 due to a buildup of contaminants in a filter medium 144, in accordance with the present disclosure. The differential electrical properties detector 180 comprises a measurement device 182, a first excitation lead 184 and a second excitation lead 186, and a first detection lead 188 and a second detection lead 190. In the illustrated embodiment, the first excitation lead 184 and the first detection lead 188 are connected to the first connector 166, discussed with respect to FIG. 3, while the second excitation lead 186 and the second detection lead 190 are connected to the second connector 170. As shown in FIG. 5, the measurement device 182 is configured to pass a test current 192 through the electrodes 162 by way of the first and second excitation leads 184, 186. The measurement device 182 is configured to measure at least the voltage across the electrodes 162 by way of the first and second detection leads 188, 190. In some embodiments, however, the measurement device 182 may be configured to measure any one or more of the voltage, resistance, capacitance, or impedance of the electrodes 162, without limitation.

In general, the measured values of any one or more of the voltage, resistance, capacitance, and impedance of the electrodes 162 will generally change over time due to a buildup of contaminants 178 (see FIG. 4). As described herein, the measured changes in electrical properties of the electrodes 162 can be used to determine a corresponding difference in pressure between a low-pressure side 164 and an atmospheric-pressure side 168 of the air filter 104 (sec FIG. 3). The pressure difference can then be used to indicate when the pressure across the filter medium 144 reaches a predetermined threshold value, at which point the air filter 104 must be serviced or replaced to minimize the energy consumption of the HVAC system 108.

With continuing reference to FIG. 5, the measurement device 182 may, in some embodiments, comprise a DAQ device or another similar device capable of performing the above-mentioned measurements. In some embodiments, the measurement device 182 may include suitable circuitry (not shown), such as one or more microcontrollers, that is capable of determining a difference in air pressure on opposite sides of the air filter 104, based on the above-mentioned measurements across the electrodes 162. In some embodiments, the circuitry may be disposed in a remote location of the HVAC system 108 and electrically coupled with the measurement device 182, such as by way of wires. When the determined pressure difference reaches a threshold value, the circuitry comprising the measurement device 182 may indicate or provide a signal to a practitioner that the air filter 104 must be cleaned or replaced. It is contemplated that the circuitry comprising the measurement device 182 may be configured to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof, as described herein.

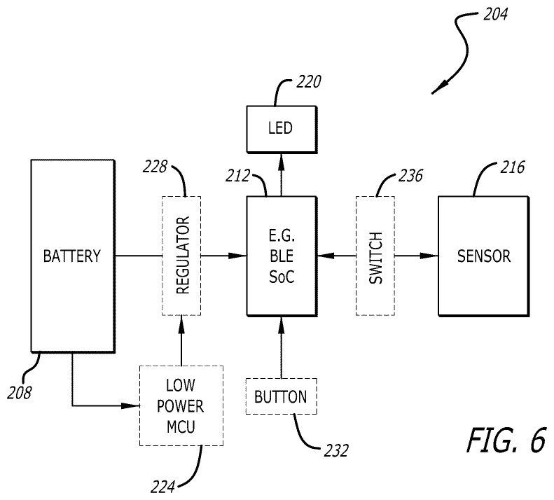

FIG. 6 is a block diagram illustrating an exemplary embodiment of power circuit 204 for supplying electrical power to a differential electrical properties detector, such as the differential electrical properties detector 160 of FIGS. 3-5. The power circuit 204 may, in some embodiments, be incorporated into a HVAC system 108 that is configured to operate with air filters that include differential electrical properties detectors. In some embodiments, however, the power circuit 204 may be incorporated into a portion of the air filter 104, such as the supportive frame 148, without limitation.

In the illustrated embodiment of FIG. 6, the power circuit 204 includes a removable battery 208, an integrated circuit 212, a sensor 216, and a light emitting diode (LED) 220. The removable battery 208 may comprise including any suitable battery chemistry, such as, by way of example, Li-ion, Lipo, NiMH, Lithium-thionyl chloride (Li—SOCl2), Alkaline cells, coin cells (CR2032), and the like, without limitation. In some embodiments, the sensor 216 may comprise the differential electrical properties detector 180 shown in FIG. 5. In some embodiments, however, the sensor 216 may comprise any sensor capable of detecting a change in selected physical properties due to a difference in pressure on opposite sides of an air filter 104, as described herein. The integrated circuit 212 may be configured to receive and process signals received from the sensor 216. The integrated circuit 212 may be configured to signal when the difference in pressure reaches a threshold value that indicates the air filter 104 needs to be cleaned or replaced.

In some embodiments, the integrated circuit 212 comprises any of a Bluetooth Low Energy System on a Chip (BLE SoC), a WiFi Module, a Bluetooth Module, and the like, without limitation. For example, in some embodiments, wherein the integrated circuit 212 is configured to communicate wirelessly by way of WiFi or Bluetooth, the integrated circuit 212 may signal an application stored on a user's mobile device to display a notification to the user when the air filter 104 needs to be cleaned or replaced. In some embodiments, the integrated circuit 212 may be configured to signal a Home Automation Gateway to send notifications to the user. Various other communication techniques will be apparent to those skilled in the art without deviating from the spirit and scope of the present disclosure.

The LED 220 may be configured to provide visual signals to a practitioner. For example, the LED 220 may illuminate to indicate when the power circuit 204 is operating. In some embodiments, however, the LED 220 may illuminate only when the air filter 104 needs to be cleaned or replaced. Further, in some embodiments, the LED 220 may illuminate with a first color when the power circuit 204 is operating normally and then change to a second color when the pressure across the air filter 104 has reached a threshold value. In some embodiments, the LED 220 may be configured to flash when the pressure has reached the threshold valve. Further, in some embodiments, the LED 220 may be coupled with a speaker or a piezoelectric device capable of issuing an audible signal. It is contemplated that in such an embodiment, the audible signals may comprise a beeping sound that accompanies the flashing of the LED 220 when the air filter 104 needs to be cleaned or replaced.

With continuing reference to FIG. 6, in some embodiments the power circuit 204 may include a low power microcontroller (MCU) 224 and/or a regulator 228, a button 232, and/or a switch 236. In some embodiments, the regulator 228 may be a linear low-quiescent-current regulator. In some embodiments, the power circuit 204 may be configured to operate at lower voltages to reduce quiescent currents, thereby obviating a need for the regulator 228. In some embodiments, however, the low power MCU 224 may be configured to operate in conjunction with the regulator 228 to regulate quiescent currents. Further, the switch 236 may comprise a MOSFET adapted to turn off unused circuitry when the integrated circuit 212 is in a quiescent state. Further, when the difference in air pressure across the air filter 104 comprises a relatively small value, the switch 236 may turn off the sensor 216 to reduce the processing load on the integrated circuit 212.

The button 232 may be configured to provide a manual interface between the power circuit 204 and a practitioner. For example, the button 232 may enable the practitioner to turn the power circuit 204 on and off, as desired. In some embodiments, the button 232 may be configured to enable the practitioner to affect the operation of the integrated circuit 212. In some embodiments, for example, the button 232 may be configured to turn off the LED 220 after the air filter 104 has been cleaned. Further, in some embodiments, the button 232 may be configured to enable the practitioner to select from among various operational modes of the power circuit 204.

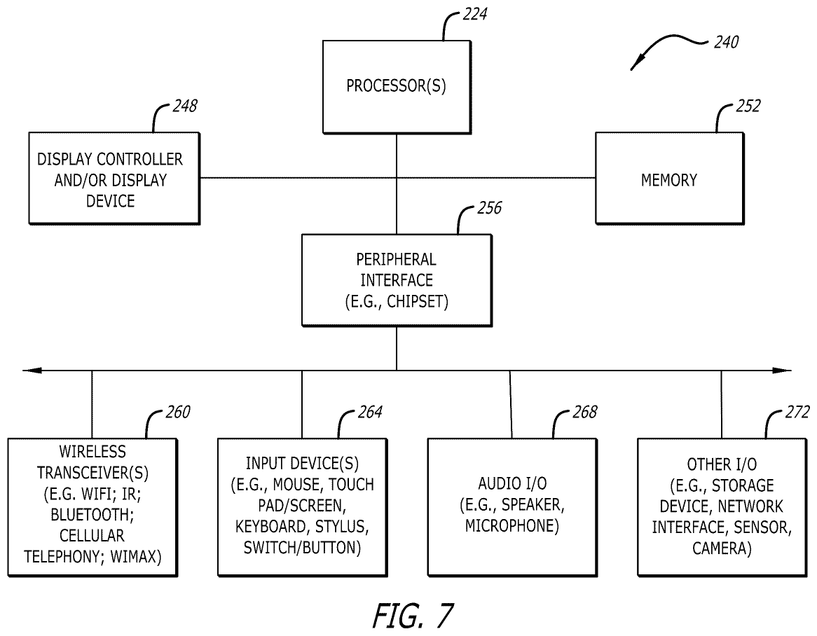

Turning, now, to FIG. 7, a block diagram illustrates an exemplary data processing system 240 that may be used in conjunction with the air filter 104 and the differential electrical properties detectors 160, 180 to perform any of the processes or methods described herein. System 240 may represent circuitry within a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 7, system 240 includes a processor 244 and a peripheral interface 256, also referred to herein as a chipset, to couple various components to the processor 244, including a memory 252 and devices 260-272 via a bus or an interconnect. Processor 244 may represent a single processor or multiple processors with a single processor core or multiple processor cores included therein. Processor 244 may represent one or more general-purpose processors such as a microprocessor, a central processing unit (CPU), or the like. More particularly, processor 244 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 244 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 244 is configured to execute instructions for performing the operations and steps discussed herein.

Peripheral interface 256 may include a memory control hub (MCH) and an input output control hub (ICH). Peripheral interface 256 may include a memory controller (not shown) that communicates with a memory 252. The peripheral interface 256 may also include a graphics interface that communicates with graphics subsystem 248, which may include a display controller and/or a display device. The peripheral interface 256 may communicate with the graphics device 248 by way of an accelerated graphics port (AGP), a peripheral component interconnect (PCI) express bus, or any other type of interconnect.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 244. In such a configuration, the peripheral interface 256 operates as an interface chip performing some functions of the MCH and ICH. Furthermore, a graphics accelerator may be integrated within the MCH or the processor 244.

Memory 252 may include one or more volatile storage (or memory) devices, such as random access memory (RAM), dynamic RAM (DRAM), synchronous DRAM (SDRAM), static RAM (SRAM), or other types of storage devices. Memory 252 may store information including sequences of instructions that are executed by the processor 244, or any other device. For example, executable code and/or data of a variety of operating systems, device drivers, firmware (e.g., input output basic system or BIOS), and/or applications can be loaded in memory 252 and executed by the processor 244. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 256 may provide an interface to IO devices, such as the devices 260-272, including wireless transceiver(s) 260, input device(s) 264, audio IO device(s) 268, and other IO devices 272. Wireless transceiver 260 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 264 may include a mouse, a touch pad, a touch sensitive screen (which may be integrated with display device 248), a pointer device such as a stylus, and/or a keyboard (e.g., physical keyboard or a virtual keyboard displayed as part of a touch sensitive screen). For example, the input device 264 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 268 may include a speaker and/or a microphone to facilitate voice-enabled functions, such as voice recognition, voice replication, digital recording, and/or telephony functions. Other optional devices 272 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 272 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 7 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Methods of the present disclosure can include, in some embodiments, fabricating a filter medium 144 comprising one or more media layers for removing contaminants from an airstream; disposing the filter medium 144 within a frame 148 for supporting the filter medium 144 within the HVAC system 108; configuring a differential electrical properties detector 160 for determining a pressure difference across the filter medium 144; and coupling the differential electrical properties detector 160 with the filter medium 144.

Configuring the differential electrical properties detector 160 comprises, in some embodiments: disposing a plurality of electrodes 162 in the filter medium 144; and incorporating a first connector 166 and a second connector 170 into the frame 148. In some embodiments, disposing the plurality of electrodes 162 comprises extending electric wires across the filter medium 144, parallel to pleats comprising the filter medium 144, and placing the electric wires into electrical communication with the first connector 166 and the second connector 170. In some embodiments, incorporating either one or more of the first connector 166 and the second connector 170 comprises configuring either one or more of the first connector 166 and the second connector 170 to interface with connectors implemented in the HVAC system 108 such that the electrodes 162 are placed into electrical communication with circuitry disposed in the HVAC system 108.

Moreover, in some embodiments, configuring the differential electrical properties detector 160 comprises configuring the circuitry to detect changes in the electrical properties of the plurality of electrodes 162 and then use the changes to determine a corresponding pressure differential across the filter 104. In some embodiments, configuring the circuitry includes configuring the circuitry to use the corresponding pressure differential to determine when the air filter 104 must be cleaned or replaced to minimize obstruction to air flow through the HVAC system 108. Further, in some embodiments, configuring the circuitry includes configuring the circuitry to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof.

The methods may include, in some embodiments, disposing the plurality of electrodes 162 comprises extending a first electrode 174 and a second electrode 176 along each pleat 172 comprising the filter medium 144. Extending the first electrode 174 and the second electrode 176 includes, in some embodiments, disposing the first electrode 174 and the second electrode 176 in the pleat 172 such that the first electrode 174 and the second electrode 176 become buried as the pleat 172 fills with a buildup of contaminants 178. Configuring the differential electrical properties detector 160 includes, in some embodiments, configuring the differential electrical properties detector 160 to detect any one or more of a resistance, a capacitance, and an impedance exhibited by the first electrode 174 and the second electrode 176. Further, configuring the differential electrical properties detector 160 includes, in some embodiments, configuring the differential electrical properties detector 160 to detect changes to any one or more of the resistance, the capacitance, and the impedance due to the buildup of contaminants 178. Further, in some embodiments, configuring the differential electrical properties detector 160 includes configuring the differential electrical properties detector 160 to use the changes to any one or more of the resistance, the capacitance, and the impedance to determine a corresponding differential pressure across the air filter 104.

In some embodiments, extending the first electrode 174 and the second electrode 176 comprises embedding gold plated wires into the pleats 172 of the filter medium 144. Further, in some embodiments, extending the first electrode 174 and the second electrode 176 comprises applying graphene-based screen-printed conductive ink to the pleats 172 of the filter medium 144. Further, in some embodiments, extending the first electrode 174 and the second electrode 176 comprise embedding copper wires into the pleats 172 of the filter medium 144.

In some embodiments, configuring the differential electrical properties detector 160 comprises coupling a measurement device 182 with a first excitation lead 184, a second excitation lead 186, a first detection lead 188, and a second detection lead 190. Further, configuring the differential electrical properties detector 160 comprises, in some embodiments, configuring the first excitation lead 184 and the first detection lead 188 to be connected to the first connector 166, while the second excitation lead 186 and the second detection lead 190 are configured to be connected to the second connector 170. In some embodiments, configuring the differential electrical properties detector 160 comprises configuring the measurement device 182 to pass a test current 192 through the electrodes 162 by way of the first excitation lead 184 and the second excitation lead 186. In some embodiments, configuring the differential electrical properties detector 160 comprises configuring the measurement device 182 to measure at least the voltage across the electrodes 162 by way of the first detection lead 188 and the second detection lead 190. Further, in some embodiments, configuring the differential electrical properties detector 160 comprises configuring the measurement device 182 to measure any one or more of the voltage, resistance, capacitance, or impedance of the electrodes 162.

While the air filter system and methods have been described in terms of particular variations and illustrative figures, those of ordinary skill in the art will recognize that the air filter is not limited to the variations or figures described. In addition, where methods and steps described above indicate certain events occurring in certain order, those of ordinary skill in the art will recognize that the ordering of certain steps may be modified and that such modifications are in accordance with the variations of the air filter system. Additionally, certain of the steps may be performed concurrently in a parallel process, when possible, as well as performed sequentially as described above. To the extent there are variations of the air filter system, which are within the spirit of the disclosure or equivalent to the air filter system found in the claims, it is the intent that this patent will cover those variations as well. Therefore, the present disclosure is to be understood as not limited by the specific embodiments described herein, but only by scope of the appended claims.

What is claimed is:

1. An air filter for a HVAC system, comprising:
a filter medium comprising one or more media layers for removing contaminants from an airstream;
a frame for supporting the filter medium within the HVAC system; and
a differential electrical properties detector for determining a pressure difference across the filter medium.

2. The air filter of claim 1, wherein the differential electrical properties detector comprises: a plurality of electrodes disposed in the filter medium; and a first connector and a second connector that are incorporated into the frame.

3. The air filter of claim 2, wherein the plurality of electrodes comprises electric wires that are extended across the filter medium, parallel to pleats comprising the filter medium, and placed into electrical communication with the first connector and the second connector.

4. The air filter of claim 2, wherein either one or more of the first connector and the second connector are configured to interface with suitable connectors implemented in the HVAC system such that the electrodes are placed into electrical communication with circuitry disposed in the HVAC system.

5. The air filter of claim 4, wherein the circuitry is configured to detect changes in the electrical properties of the plurality of electrodes and then use the changes to determine a corresponding pressure differential across the filter.

6. The air filter of claim 5, wherein the circuitry is configured to use the corresponding pressure differential to determine when the air filter must be cleaned or replaced to minimize obstruction to air flow through the HVAC system.

7. The air filter of claim 6, wherein the circuitry is configured to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof.

8. The air filter of claim 2, wherein the plurality of electrodes comprises a first electrode and a second electrode are disposed in, and extended along, each pleat comprising the filter medium.

9. The air filter of claim 8, wherein the first electrode and the second electrode are disposed in the pleat such that the first electrode and the second electrode become buried as the pleat fills with a buildup of contaminants.

10. The air filter of claim 9, wherein the differential electrical properties detector is configured to detect any one or more of a resistance, a capacitance, and an impedance exhibited by the first electrode and the second electrode.

11. The air filter of claim 10, wherein the differential electrical properties detector is configured to detect changes to any one or more of the resistance, the capacitance, and the impedance due to the buildup of contaminants.

12. The air filter of claim 11, wherein the differential electrical properties detector is configured to use the changes to any one or more of the resistance, the capacitance, and the impedance to determine a corresponding differential pressure across the air filter.

13. The air filter of claim 8, wherein the first electrode and the second electrode comprise gold plated wires that are embedded into the pleats of the filter medium.

14. The air filter of claim 8, wherein the first electrode and the second electrode comprise graphene-based screen-printed conductive ink that is applied to the pleats of the filter medium.

15. The air filter of claim 8, wherein the first electrode and the second electrode comprise copper wires that are embedded into the pleats of the filter medium.

16. The air filter of claim 2, wherein the differential electrical properties detector comprises a measurement device, a first excitation lead and a second excitation lead, and a first detection lead and a second detection lead.

17. The air filter of claim 16, wherein the first excitation lead and the first detection lead are configured to be connected to the first connector, while the second excitation lead and the second detection lead are configured to be connected to the second connector.

18. The air filter of claim 16, wherein the measurement device is configured to pass a test current through the electrodes by way of the first excitation lead and the second excitation lead.

19. The air filter of claim 18, wherein the measurement device is configured to measure at least the voltage across the electrodes by way of the first detection lead and the second detection lead.

20. The air filter of claim 16, wherein the measurement device is configured to measure any one or more of the voltage, resistance, capacitance, or impedance of the electrodes.
